(19) United States
(12) Patent Application Publication
(10) Pub. No.: US 2025/0235852 A1
(43) Pub. Date: Jul. 24, 2025

(54) EXHAUST GAS PURIFICATION CATALYST

(71) Applicants: Takahiro NISHIO, Nagoya-shi (JP); Takumi TOJO, Tajimi-shi (JP); Nobuyuki TAKAGI, Toyota-shi (JP); Nobusuke KABASHIMA, Toyota-shi (JP); Sho HOSHINO, Hamamatsu-shi (JP); Shun SAKAMOTO, Iwata-shi (JP); Naoto FUJITA, Hamamatsu-shi (JP); Yosuke TODA, Iwata-shi (JP); Kengo SHIMIZU, Iwata-shi (JP)

(72) Inventors: Takahiro NISHIO, Nagoya-shi (JP); Takumi TOJO, Tajimi-shi (JP); Nobuyuki TAKAGI, Toyota-shi (JP); Nobusuke KABASHIMA, Toyota-shi (JP); Sho HOSHINO, Hamamatsu-shi (JP); Shun SAKAMOTO, Iwata-shi (JP); Naoto FUJITA, Hamamatsu-shi (JP); Yosuke TODA, Iwata-shi (JP); Kengo SHIMIZU, Iwata-shi (JP)

(73) Assignees: TOYOTA JIDOSHA KABUSHIKI KAISHA, Toyota-shi (JP); CATALER CORPORATION, Kakegawa-shi (JP)

(21) Appl. No.: 18/975,661

(22) Filed: Dec. 10, 2024

(30) Foreign Application Priority Data
Jan. 11, 2024 (JP) 2024-002479

(51) Int. Cl. B01J 23/63; B01D 53/94; B01J 23/10; B01J 35/00; B01J 35/40; B01J 37/00; B01J 37/02; F01N 3/28

(52) U.S. Cl. CPC B01J 23/63; B01D 53/9468; B01J 23/10; B01J 35/19; B01J 35/40; B01J 37/0018; B01J 37/0228; B01J 37/0244; F01N 3/2803; B01D 2255/1023; B01D 2255/1025; B01D 2255/407; B01D 2255/9022; B01D 2255/908; B01D 2255/9202; B01D 2258/01; F01N 2370/02; F01N 2510/068

(57) ABSTRACT

The present disclosure provides an exhaust gas purification catalyst improved in structural stability. The present disclosure relates to an exhaust gas purification catalyst including a substrate and a catalyst layer disposed on the substrate. The catalyst layer has a two-layer structure including a first coat layer formed on the substrate and a second coat layer formed on the first coat layer. The first coat layer contains alumina and an OSC material. The alumina has an average particle diameter of 6.0 μm or more, and the OSC material has an average particle diameter of 6.0 μm or more. The OSC material is a ceria-zirconia-based composite oxide without alumina.

### CROSS REFERENCE TO RELATED APPLICATIONS

The present application claims priority from Japanese patent application JP 2024-002479 filed on Jan. 11, 2024, the entire content of which is hereby incorporated by reference into this application.

### BACKGROUND

### Technical Field

The present disclosure relates to an exhaust gas purification catalyst.

### Background Art

An exhaust gas discharged from an internal combustion engine of an automobile and the like contains harmful gas of carbon monoxide (CO), nitrogen oxide (NOx), unburned hydrocarbon (HC), and the like. To decompose such a harmful gas, an exhaust gas purification catalyst (what is called a three-way catalyst) is used. As the exhaust gas purification catalyst, one including a substrate coated with a catalyst layer is widely used. For the catalyst layer of the exhaust gas purification catalyst, in addition to catalyst metals, an oxygen absorption/release material (also referred to as an OSC material) having an oxygen absorption/release capacity (also referred to as an Oxygen Storage Capacity (OSC)) is widely used (for example, JP 2018-38999 A). The oxygen absorption/release material absorbs and releases oxygen, and adjusts an air-fuel ratio (A/F). Thus, reduction in purification rate due to fluctuation of exhaust gas composition can be suppressed.

On the other hand, under the recent emissions regulations, it is desired to maintain the purification performance even in traveling a longer distance. Therefore, the exhaust gas purification catalyst is required to have further improved structural stability. However, in the exhaust gas purification catalyst using the OSC material, the coat layer peels off from the substrate during the use over a long period of time, and the purification performance is impaired in some cases. This is considered to be caused by the following reasons. Specifically, the OSC material thermally shrinks due to the oxygen absorption/release, and the difference in shrinkage from other materials and the substrate reduces the structural stability. Consequently, the strength between the substrate and the coat layer is reduced, and the coat layer peels off from the substrate.

Japanese Patent No. 6820739 deals with this problem by providing a catalyst coat layer on a honeycomb substrate via an anti-peeling coat layer containing alumina particles as a main component. However, the presence of the anti-peeling coat layer increases the coat thickness, possibly affecting the engine output. Therefore, it is desired to avoid forming a layer having only a function of anti-peeling.

### SUMMARY

As described above, the conventional exhaust gas purification catalyst using the OSC material is required to have the improved structural stability. Accordingly, the present disclosure provides an exhaust gas purification catalyst improved in structural stability.

The inventors found that the structural stability of a catalyst is improved by controlling average particle diameters of alumina and an OSC material to specific ranges in a lower layer of a catalyst layer, thus completing the present disclosure.

That is, the gist of the present disclosure is as follows.
(1) An exhaust gas purification catalyst comprises a substrate and a catalyst layer disposed on the substrate. The catalyst layer has a two-layer structure including a first coat layer formed on the substrate and a second coat layer formed on the first coat layer. The first coat layer contains alumina and an OSC material. The alumina has an average particle diameter of 6.0 μm or more, and the OSC material has an average particle diameter of 6.0 μm or more. The OSC material is a ceria-zirconia-based composite oxide without alumina.
(2) In the exhaust gas purification catalyst according to (1), the average particle diameter of the alumina is from 6.0 μm to 12.0 μm, and the average particle diameter of the OSC material is from 6.0 μm to 12.0 μm.
(3) In the exhaust gas purification catalyst according to (1) or (2), the ceria-zirconia-based composite oxide has a fluorite structure and does not contain Pr.
(4) In the exhaust gas purification catalyst according to any of (1) to (3), the first coat layer contains Pd as a catalyst metal.

The present disclosure can provide the exhaust gas purification catalyst improved in structural stability.

### BRIEF DESCRIPTION OF THE DRAWINGS

FIG. 1 is a graph illustrating an OSC performance and a peeling rate after a durability test of catalysts of Examples 1 to 6 and Comparative Example 1;

FIG. 2 is a graph illustrating the OSC performance and the peeling rate after the durability test of the catalysts of Comparative Example 1 and Comparative Example 3; and

FIG. 3 is a graph illustrating the OSC performance and the peeling rate after the durability test of the catalysts of Example 3 and Comparative Example 2.

### DETAILED DESCRIPTION

The following describes embodiments of the present disclosure in detail.

An exhaust gas purification catalyst (hereinafter also referred to as a catalyst) of the present disclosure comprises a substrate and a catalyst layer disposed on the substrate.

As the substrate, a honeycomb-shaped material with multiple cells can be used. Examples of the material of the substrate include a ceramic material having heat resistance and a metal material, such as stainless steel. Examples of the ceramic material include cordierite (2MgO·2Al₂O₃·5SiO₂), alumina, zirconia, and silicon carbide.

The catalyst layer has a two-layer structure including a first coat layer and a second coat layer.

The first coat layer is formed on the substrate. That is, the first coat layer is in contact with the substrate. The first coat layer has a coat width that is ordinarily a length of 50% to 100%, and a length of 100% in one embodiment with respect to the whole length of the substrate.

The first coat layer contains alumina (Al₂O₃) and an OSC material. In the present disclosure, by controlling average particle diameters of alumina and the OSC material in the first coat layer in contact with the substrate to specific ranges, the coat layer can be suppressed to peel off from the substrate while the OSC performance is ensured.

Alumina may have a form in which an oxide of another metallic element is combined with Al₂O₃. However, the oxide of the other metallic element is an oxide of a metallic element other than cerium (Ce) or zirconium (Zr). Examples of the oxide of the other metallic element include La₂O₃ and Y₂O₃. The content of the oxide of the other metallic element is ordinarily 10% by weight or less, 5% by weight or less in some embodiments, and 1% by weight or less in some embodiments.

In the first coat layer, the content of alumina is ordinarily 10 g/L to 50 g/L with respect to the substrate volume.

In the first coat layer, alumina has the average particle diameter of 6.0 μm or more, and from the aspect of high structural stability and sufficiently low pressure loss, 6.0 μm to 12.0 μm in some embodiments, and 8.0 μm to 10.0 μm in some embodiments. The average particle diameter of alumina in the first coat layer can be obtained by measuring particle diameters of 50 alumina particles contained in the first coat layer and calculating the average particle diameter. This measurement can be performed, for example, using Electron Probe Micro Analyzer (EPMA).

The OSC material contained in the first coat layer is a ceria (CeO₂)-zirconia (ZrO₂)-based composite oxide without alumina. While the OSC material containing alumina provides an effect of suppressing peeling off of the coat layer, the OSC performance is reduced due to a reduced ceria usage efficiency. In the present disclosure, by controlling the average particle diameters of alumina and the OSC material in the first coat layer, peeling off of the coat layer can be suppressed. Therefore, even when the OSC material without alumina is used, the high OSC performance can be achieved while suppressing peeling off of the coat layer. The OSC material may contain an oxide of a metallic element other than aluminum (Al), Ce, or Zr. Such an oxide of the metallic element is not especially limited, and examples thereof include Nd₂O₃, La₂O₃, and Y₂O₃. In one embodiment, the OSC material does not contain an oxide of praseodymium (Pr) or Pr. The content of zirconia in the OSC material is, from the aspect of high OSC performance, ordinarily 30% by weight or more, and for example, 40% by weight or more or 50% by weight or more. In one embodiment, the content of zirconia in the OSC material is 30% by weight to 80% by weight, and 40% by weight to 80% by weight in some embodiments.

In one embodiment, the ceria-zirconia-based composite oxide has a fluorite structure. In one embodiment, the ceria-zirconia-based composite oxide has a fluorite structure, and does not contain Pr.

In the first coat layer, the content of the OSC material is ordinarily 20 g/L to 100 g/L, and 40 g/L to 80 g/L in some embodiments with respect to the substrate volume.

In the first coat layer, the OSC material has the average particle diameter of 6.0 μm or more, and from the aspect of high structural stability and sufficiently low pressure loss, 6.0 μm to 12.0 μm in some embodiments, and 8.0 μm to 10.0 μm in some embodiments. The average particle diameter of the OSC material in the first coat layer can be obtained by, similarly to alumina, measuring particle diameters of 50 OSC material particles contained in the first coat layer and calculating the average particle diameter. This measurement can be performed, for example, using EPMA device.

The first coat layer may contain a catalyst metal in addition to alumina and the OSC material. The catalyst metal is not especially limited, and examples thereof include a noble metal. As the catalyst metal, for example, a platinum group metal, such as ruthenium (Ru), rhodium (Rh), palladium (Pd), osmium (Os), iridium (Ir), and platinum (Pt), can be used. In one embodiment, the catalyst metal is Pd. In the first coat layer, the content of the catalyst metal is ordinarily 0.1 g/L to 1.5 g/L with respect to the substrate volume.

The second coat layer is formed on the first coat layer. The second coat layer has a coat width that is ordinarily a length of 50% to 100%, and a length of 100% in one embodiment with respect to the whole length of the substrate. The second coat layer contains, for example, a catalyst metal, an OSC material, and a metal oxide other than the OSC material.

In the second coat layer, as the catalyst metal, the catalyst metals described for the first coat layer can be used. In one embodiment, the catalyst metal is Rh. The catalyst metal may be used in a form supported on the OSC material or the metal oxide. In the second coat layer, the content of the catalyst metal is ordinarily 0.01 g/L to 1.0 g/L with respect to the substrate volume.

In the second coat layer, examples of the OSC material include ceria and a composite oxide containing ceria (for example, ceria-zirconia-based composite oxide). The ceria-zirconia-based composite oxide may contain an oxide of a metallic element other than Ce or Zr. Such an oxide of the metallic element is not especially limited, and examples thereof include Nd₂O₃, La₂O₃, and Y₂O₃. The content of zirconia in the OSC material is ordinarily 50% by weight or more, and for example, 60% by weight or more or 70% by weight or more. In one embodiment, the content of zirconia in the OSC material is 50% by weight to 90% by weight.

In the second coat layer, the content of the OSC material is ordinarily 20 g/L to 100 g/L with respect to the substrate volume.

In the second coat layer, examples of the metal oxide other than the OSC material include alumina and a composite oxide of alumina and an oxide of another metallic element (for example, zirconia). As alumina, those described for the first coat layer can be used. In the second coat layer, the total content of the metal oxide is ordinarily 20 g/L to 100 g/L with respect to the substrate volume.

The catalyst of the present disclosure can be produced by coating a substrate with a slurry containing the components of the coat layer by a method publicly known to those skilled in the art. In one embodiment, for example, a substrate is coated with a first slurry containing components of a first coat layer in a predetermined range from a substrate end surface, and then dried and fired, thus forming the first coat layer on the substrate. Subsequently, the substrate is coated with a second slurry containing components of a second coat layer in a predetermined range from a substrate end surface in the opposite side of the first slurry, and then dried and fired, thus forming the second coat layer on the first coat layer. The first slurry is obtained by, for example, dispersing a solid material containing the components of the first coat layer in a solvent, such as water. The average particle diameters of alumina and the OSC material in the first coat layer can be controlled by adjusting an average particle diameter of the solid material containing the components of the first coat layer. The catalyst of the present disclosure is obtained using, for example, the first slurry in which the average particle diameter of the solid material is adjusted to 6.0 μm or more (in one embodiment, 6.0 μm to 12.0 μm). In the present disclosure, the average particle diameter of the solid material means a 50% cumulative particle diameter (also referred to as a median diameter or D50) based on the volume. The average particle diameter (D50) of the solid material can be measured by, for example, a laser diffraction scattering method. The more the average particle diameter of the solid material containing the components of the first coat layer increases, the more the average particle diameters of alumina and the OSC material in the first coat layer of the obtained catalyst increase.

### EXAMPLES

The following further specifically describes the present disclosure using examples. However, the technical scope of the present disclosure is not limited to these examples.

### <Catalyst Preparation>

### Used Raw Materials

Material 1 (Al₂O₃): La₂O₃ composite Al₂O₃ (La₂O₃: 1% by weight)
Material 2 (CZ): CeO₂—ZrO₂ composite oxide (CeO₂: 40% by weight; ZrO₂: 50% by weight; a trace of Nd₂O₃, La₂O₃, and Y₂O₃ are added, and high heat resistance process is performed)
Material 3 (CZ): CeO₂—ZrO₂ composite oxide (CeO₂: 20% by weight; ZrO₂: 70% by weight; a trace of Nd₂O₃, La₂O₃, Y₂O₃ are added, and high heat resistance process is performed)
Material 4 (AZ): Al₂O₃—ZrO₂ composite oxide (Al₂O₃: 30% by weight; ZrO₂: 60% by weight; a trace of Nd₂O₃, La₂O₃, and Y₂O₃ are added, and high heat resistance process is performed)
Material 5 (Ba sulfate): barium sulfate
Material 6 (Pd): palladium nitrate
Material 7 (Rh): rhodium nitrate
Material 8 (ACZ): Al₂O₃—CeO₂—ZrO₂ composite oxide (Al₂O₃: 20% by weight; CeO₂: 40% by weight; ZrO₂: 30% by weight; a trace of Nd₂O₃, La₂O₃, and Y₂O₃ are added, and high heat resistance process is performed)
Substrate: cordierite honeycomb substrate of 875 cc (600 cells, hexagon, wall thickness 2 mil)

### Comparative Example 1

First, palladium nitrate (Material 6), Al₂O₃(Material 1), CZ (Material 2), barium sulfate (Material 5), and an Al₂O₃-based binder were introduced into distilled water while being stirred, thus preparing a suspended slurry 1. At this time, an average particle diameter (D50) of a solid material for the slurry 1 was adjusted to 4.5 μm. The slurry 1 was casted into the substrate and the excess was blown off with a blower, thus coating a substrate wall surface with the materials. At this time, for the coating materials, with respect to the substrate volume, the coating was performed with Material 6 as Pd of 0.75 g/L-zone, Material 1 of 20 g/L-zone, Material 2 of 60 g/L-zone, and Material 5 of 10 g/L-zone. The coat width was adjusted to 100% with respect to the whole length of the substrate. At last, after the water content was reduced for two hours with a dryer kept at 120° C., two hours of firing was performed with an electric furnace kept at 500° C., thus preparing the first coat layer (lower layer).

Rhodium nitrate (Material 7) and AZ (Material 4) were introduced into distilled water while being stirred, and dried and fired, thus preparing Rh/AZ in which Rh is supported on AZ. Rh/AZ, Al₂O₃(Material 1), CZ (Material 3), and an Al₂O₃-based binder were introduced into distilled water while being stirred, thus preparing a suspended slurry 2. At this time, an average particle diameter (D50) of a solid material for the slurry 2 was adjusted to 4.5 μm. The slurry 2 was casted into the substrate over which the slurry 1 was applied from an end surface in the opposite side of the slurry 1, and the excess was blown off with a blower, thus coating the substrate wall surface with the materials. At this time, for the coating materials, with respect to the substrate volume, the coating was performed with Material 7 as Rh of 0.25 g/L-zone, Material 1 of 30 g/L-zone, Material 3 of 60 g/L-zone, and Material 4 of 30 g/L-zone. The coat width was adjusted to 100% with respect to the whole length of the substrate. At last, after the water content was reduced for two hours with a dryer kept at 120° C., two hours of firing was performed with an electric furnace kept at 500° C., thus preparing the second coat layer (upper layer).

In the first coat layer of the obtained catalyst of Comparative Example 1, the average particle diameter of alumina (Al₂O₃) was 4.9 μm, and the average particle diameter of the OSC material (CZ) was 4.3 μm.

### Comparative Example 2

The preparation was performed similarly to Comparative Example 1 except that Material 2 (CZ) of the slurry 1 was changed to Material 8 (ACZ).

### Comparative Example 3

The preparation was performed similarly to Comparative Example 1 except that the average particle diameter of the solid material for the slurry 2 was changed to 8.0 μm.

### Example 1

The preparation was performed similarly to Comparative Example 1 except that the average particle diameter of the solid material for the slurry 1 was changed to 6.0 μm. In the first coat layer of the obtained catalyst of Example 1, the average particle diameter of alumina (Al₂O₃) was 6.4 μm, and the average particle diameter of the OSC material (CZ) was 6.0 μm.

### Example 2

The preparation was performed similarly to Comparative Example 1 except that the average particle diameter of the solid material for the slurry 1 was changed to 6.5 μm.

### Example 3

The preparation was performed similarly to Comparative Example 1 except that the average particle diameter of the solid material for the slurry 1 was changed to 7.0 μm.

### Example 4

The preparation was performed similarly to Comparative Example 1 except that the average particle diameter of the solid material for the slurry 1 was changed to 8.0 μm. In the first coat layer of the obtained catalyst of Example 4, the average particle diameter of alumina (Al₂O₃) was 8.3 μm, and the average particle diameter of the OSC material (CZ) was 8.2 μm.

### Example 5

The preparation was performed similarly to Comparative Example 1 except that the average particle diameter of the solid material for the slurry 1 was changed to 10.0 μm.

### Example 6

The preparation was performed similarly to Comparative Example 1 except that the average particle diameter of the solid material for the slurry 1 was changed to 12.0 μm. In the first coat layer of the obtained catalyst of Example 6, the average particle diameter of alumina (Al₂O₃) was 12.0 μm, and the average particle diameter of the OSC material (CZ) was 11.7 μm.

### <Measurement of Average Particle Diameter>

The average particle diameter (D50) of the solid material for the slurry 1 was measured by a laser diffraction scattering method using a laser scattering particle size distribution analyzer (manufactured by HORIBA, Partica LA-960).

For each of the catalysts of Examples 1, 4, 6 and Comparative Example 1, particle diameters of alumina (Al₂O₃) and the OSC material (CZ) of the first coat layer (lower layer) were measured at 50 points for each material using EPMA device (manufactured by JEOL, JXA-8530F), and the average particle diameters were calculated.

### <Durability Test>

The durability test was performed for each of the prepared catalysts using an actual engine. Specifically, the durability test was performed as follows. The catalysts were each installed to an exhaust system of a V-type eight-cylinder engine, exhaust gases in respective stoichiometric and lean atmospheres were repeatedly flowed for a certain period of time (a ratio of 3:1) at a catalyst bed temperature of 950° C. for 50 hours.

### <Performance Evaluation>

For each of the catalysts subjected to the durability test, the performance was evaluated using an actual engine. Specifically, the catalysts were each installed to an exhaust system of a L-type four-cylinder engine, and the OSC performance evaluation and the peeling evaluation were performed under the following conditions.

### OSC Performance Evaluation

The exhaust gas having air-fuel ratio (A/F) of from 14.4 to 15.1 was supplied, and the oxygen absorption/release capacity when the rich and the lean are repeated in a short period was measured. It is indicated that the larger the value is, the more an A/F variation of the gas discharged from the engine can be absorbed, thus an atmosphere inside the catalyst can be held around a stoichiometric state and a high purification performance can be maintained.

### Peeling Evaluation

Similarly to “Measurement of Catalyst Coat Layer Peeling Rate” in the example of Japanese Patent No. 6820739, the peeling evaluation was performed.

Specifically, the prepared catalysts were each cut in a cube of 18 mm×18 mm×18 mm, and used as measurement samples. The measurement sample was put in a magnetic crucible, and a heating process was performed in air at 1050° C. for five hours. The mass of the coat layer peeled off and fallen into the crucible during the heating process was weighed and recorded as “Mass 1.” The mass of the measurement sample after the heating process was weighed, and recorded as a mass before applying vibration (Mass 2). The measurement sample after the heating process was hooked onto a jig with a bent tip of a wire and suspended in a cleaning tank of an ultrasonic cleaner, and an ultrasonic sound wave having a frequency of 40 to 45 kHz and a sound pressure of 10 to 12 mV was applied for 10 minutes. The measurement sample after the ultrasonic sound wave application was collected, dried at 180° C. for one hour or more, and then weighed, and a mass after the vibration application (Mass 3) was examined. Using the Mass 1, Mass 2, and Mass 3 described above, the coat layer peeling rate was calculated with a formula (1) below.

coat layer peeling rate (%)=[((Mass 1+Mass 2)−Mass 3)/(Mass 1+Mass 2)]×100(1)

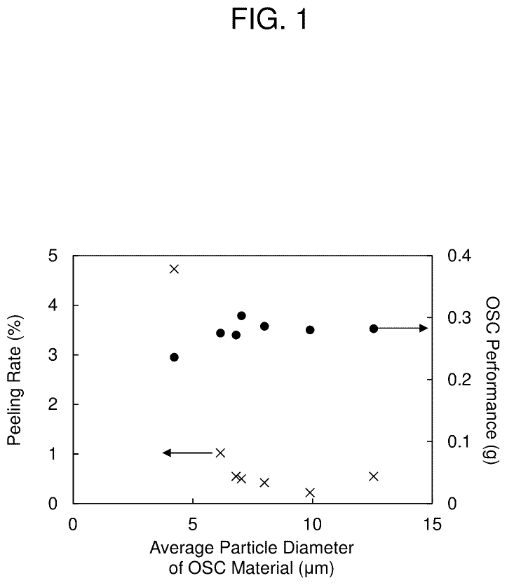

Table 1 and FIG. 1 illustrate the OSC performance and the peeling rate after the durability test of the catalysts of Examples 1 to 6 and Comparative Example 1 different in average particle diameter of the material of the first coat layer (lower layer). In FIG. 1, for the values of “Average Particle Diameter of OSC Material,” the values of the average particle diameter of the solid material for the first slurry were used. The more the average particle diameter of the material in the slurry increases, the more the average particle diameter of the material in the coat layer obtained using the slurry increases.

TABLE 1

| | Peeling | | |
|---|---|---|---|
| | Rate after | OSC | |
| | Durability | Performance | |
| | Test (%) | (g) | Supplement |
| Example 1 | 1.02 | 0.275 | |
| Example 2 | 0.55 | 0.272 | |
| Example 3 | 0.50 | 0.303 | |
| Example 4 | 0.42 | 0.286 | |
| Example 5 | 0.22 | 0.280 | |
| Example 6 | 0.55 | 0.282 | |
| Comparative | 4.73 | 0.236 | |
| Example 1 | | | |
| Comparative | 0.87 | 0.252 | Material 2 (CZ) was changed |
| Example 2 | | | to Material 8 (ACZ). |
| Comparative | 3.55 | 0.254 | Average particle diameter |
| Example 3 | | | of upper layer material was |
| | | | adjusted to 8.0 μm. |

As illustrated in Table 1 and FIG. 1, increasing the average particle diameter of the OSC material of the first coat layer (lower layer) enabled suppressing peeling off of the coat layer after the durability test while ensuring the OSC performance. This is considered because the increased average particle diameter of the OSC material enabled suppressing thermal shrinkage of the OSC material, and consequently, the structural stability was improved.

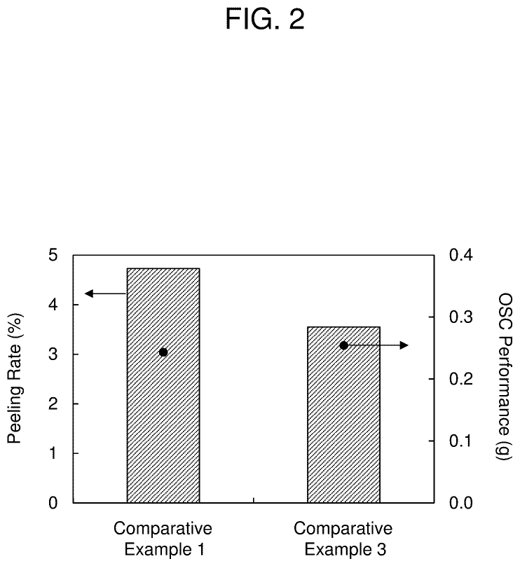

FIG. 2 illustrates the OSC performance and the peeling rate after the durability test of the catalysts of Comparative Example 1 and Comparative Example 3 different in average particle diameter of the material of the second coat layer (upper layer). As illustrated in Table 1 and FIG. 2, also in the case where the average particle diameter of the material of the upper layer not in contact with the substrate was controlled, the peeling off of the coat layer after the durability test was able to be suppressed. However, the peeling suppression effect of this case was substantially reduced compared with the case where the average particle diameter of the material of the lower layer was controlled.

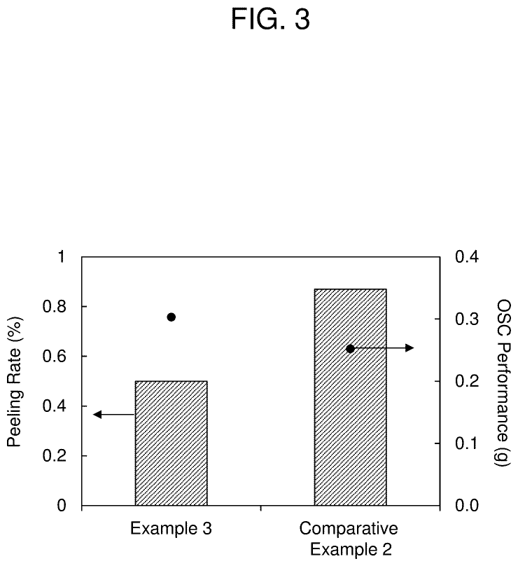

FIG. 3 illustrates the OSC performance and the peeling rate after the durability test of the catalysts of Example 3 and Comparative Example 2 different in used material and average particle diameter of the material of the first coat layer (lower layer). In the catalyst of Example 3, the average particle diameter of the material of the lower layer is in the range of the present disclosure, and the OSC material contained in the lower layer is a CeO₂—ZrO₂ composite oxide. On the other hand, in the catalyst of Comparative Example 2, the average particle diameter of the material of the lower layer is out of the range of the present disclosure, and the OSC material contained in the lower layer is an Al₂O₃—CeO₂—ZrO₂ composite oxide. As illustrated in Table 1 and FIG. 3, in the catalyst of Example 3, the peeling off of the coat layer after the durability test was significantly suppressed and the OSC performance was high compared with the catalyst of Comparative Example 2.

All publications, patents, and patent applications cited herein are incorporated herein by reference in their entirety.

What is claimed is:

1. An exhaust gas purification catalyst comprising:
a substrate; and
a catalyst layer disposed on the substrate,
wherein the catalyst layer has a two-layer structure including a first coat layer formed on the substrate and a second coat layer formed on the first coat layer,
wherein the first coat layer contains alumina and an OSC material,
wherein the alumina has an average particle diameter of 6.0 μm or more, and the OSC material has an average particle diameter of 6.0 μm or more, and
wherein the OSC material is a ceria-zirconia-based composite oxide without alumina.

2. The exhaust gas purification catalyst according to claim 1,
wherein the average particle diameter of the alumina is from 6.0 μm to 12.0 μm, and the average particle diameter of the OSC material is from 6.0 μm to 12.0 μm.

3. The exhaust gas purification catalyst according to claim 1,
wherein the ceria-zirconia-based composite oxide has a fluorite structure and does not contain Pr.

4. The exhaust gas purification catalyst according to claim 1,
wherein the first coat layer contains Pd as a catalyst metal.
